(19) United States
(12) Patent Application Publication
(10) Pub. No.: US 2003/0077563 A1
(43) Pub. Date: Apr. 24, 2003

(54) Erasable coloring device

(76) Inventor: Herbert B. Farmer, Salt Lake City, UT (US)

Correspondence Address: MALLINCKRODT & MALLINCKRODT, 10 EXCHANGE PLACE, SUITE 510, SALT LAKE CITY, UT, 84111, US

(21) Appl. No.: 10/167,247

(22) Filed: Jun. 10, 2002

Related U.S. Application Data
(60) Provisional application No. 60/297,476, filed on Jun. 11, 2001.

(51) Int. Cl. B43L 1/00

(52) U.S. Cl. 434/408

(57) ABSTRACT

An erasable coloring device includes erasable material upon which a user can color and guide indicia which a user uses to guide the user in coloring an area on the erasable material to be colored by the user. In several embodiments, such coloring device includes outline indicia permanently printed on the erasable material to outline areas to be colored by a user. Similar indicia is permanently printed with outline areas colored in to serve as the guide for a user coloring the outline indicia. The device can take the form of a coloring book wherein, when the book is open, the outline indicia appears on one page of the book and the similar indicia appears on the facing page so that a user can see both the outline indicia and the similar indicia simultaneously. Text can be included in the book as desired to explain the outline indicia or to tell a story where the outline indicia represents pictures connected with the story. The device can also take the form of posters, tray liners, place mats, greeting cards, games, and other items. The similar indicia can be positioned so it can be seen simultaneously with coloring the outline indicia, can be positioned on other surfaces of the material, or positioned separately from the material.

### RELATED APPLICATION

This application claims the benefit of provisional Application Serial No. 60/297,476, filed Jun. 11, 2001, and entitled “ERASABLE COLORING DEVICE.”

### BACKGROUND OF THE INVENTION

Field: The invention is in the field of activities for children and particularly in the field of coloring books and other items, such as greeting cards, that contain outline areas to be colored by a child.

State of the Art: Coloring books include outline drawings having areas within the outline drawings for a child to fill in with color, generally by use of a coloring instrument such as a crayon, marker, or colored pencil. Once colored, the coloring done is permanent and the child cannot recolor a particular drawing or portion thereof that has already been colored. Further, a child is completely on his or her own in selecting appropriate colors to use in coloring a particular drawing, and if a small child without experience with the thing pictured, the child my have no idea of an appropriate color to use for a particular thing pictured.

Various items, such as place mats, have been made of plastic material, or of paper which is laminated with plastic material, to provide a plastic surface which can be colored with crayons and the crayon coloring later wiped or washed off so the item can be colored multiple times. U.S. Pat. No. 3,777,418 shows a lunch box with plastic laminated sides which provide a smooth plastic surface which can be colored, wiped clean, and recolored. U.S. Patent No. 3,783,553 shows a doll with a face of a semi-rigid vinyl material that can accept crayon markings which can later be erased so the face can be changed as desired by the owner. U.S. Pat. No. 5,547,198 shows a game with a board having a plastic like surface upon which a player can color as directed during play of the game. The board is wiped clean at the end of a game so the game can be played over and over as desired.

U.S. Pat. No. 5,213,507 shows a picture book for children with story text on a page or portion of a page next to a picture relating to the text. The picture may be an outline picture to be colored by a child reading the book, and preferably is in the form of a puzzle with the puzzle pieces being plastic coated so that the puzzle may be colored by a user and then erased for reuse. The text relates to the picture so gives the child some understanding of the picture. The idea is that the text relates to the picture and the child develops skills in reading the text, assembling the puzzle, and in coloring the puzzle. However, there is no teaching of or providing an example of how the picture, whether or not a puzzle, can be appropriately colored.

### SUMMARY OF THE INVENTION

According to the invention, an item to be colored, such as a coloring book, a reader with pictures to be colored, a greeting card, a game board, or a poster, is made of or includes a flexible paper-like material from which crayon or selected other color markings can be easily wiped or washed, i.e., erased. In most embodiments, such item includes a permanent outline drawing to be colored and a similar outline drawing with colors permanently printed thereon so as not to be erasable to serve as a guide to show an appropriate way to color the outline drawing. With a coloring book, for example, the outlined drawing to be colored and the similar colored outlined drawing are positioned to be side-by-side when a page of the book is opened so that the user can simultaneously see both drawings and easily use the similar outlined drawing as a guide in coloring the outlined drawing to be colored. With a poster or like item, the similar outlined drawing may be printed on one side of the item and the outlined drawing to be colored on the opposite side. With a greeting card, or with a poster or like item, the similar outlined drawing may be supplied on a separate sheet removably attached to or otherwise positioned with the item to be colored. With a game board, the similar outlined drawing may be provided on the game board adjacent the outlined drawing to be colored or on a separate sheet positioned with the game board when supplied to the user. An important aspect of the invention is that the similar outlined drawing is supplied with the outlined drawing to be colored to serve as a guide to coloring the outlined drawing to be colored. A further important aspect of the invention is that the outlined drawing to be colored is permanently printed on a paper like material from which color markings can be easily erased therefrom.

While in some cases color selection is an exercise in artistic development, for most children, looking at a drawing and learning appropriate colors for particular items with which they have had little or no experience is itself an educational experience. Also, an indication of the use of different colors for different areas and that such colors are applied only within certain outlined areas may be an important learning exercise and help teach coloring techniques and skills.

In an alternate embodiment of the invention, the item may include a blank area of the erasable material which forms an area to be colored by the user along with one or more printed drawings adjacent the blank area forming guide indicia so that a user can try to copy the printed drawing or selected drawing in the blank area. The user can easily erase his or her attempted copy of the printed drawing and try again. Here, again, the important feature is that the printed drawing is supplied as a guide to the user in producing his or her own drawing, which can be erased so the user can re-do his or her drawing from time to time as desired.

### THE DRAWINGS

The best mode presently contemplated for carrying out the invention is illustrated in the accompanying drawings in which:

FIG. 1 is a perspective view of a coloring book of the invention;

FIG. 2, a perspective view of a poster of the invention showing a comer of the poster curved over;

FIG. 3, a perspective view of a greeting card of the invention;

FIG. 4, a top plan view of a game board of the invention; and

FIG. 5, a top plan view of an embodiment of the invention with blank coloring areas.

### DETAILED DESCRIPTION OF THE ILLUSTRATED EMBODIMENT

In the embodiment of FIG. 1, the invention takes the form of a coloring book. The book has a front cover 10 and back cover 11, with pages 12 therebetween. Any number of pages 12 can be included. The pages 12 are made of a paper like material which can be colored upon with coloring instruments such as crayons or washable markers and from which such color markings can be erased or washed. A waterproof or water resistant, flexible, tear resistant material is preferred, and a multicellular film synthetic paper material sold under the Trademark POLYART by Arjobex America of Charlotte, N.C. has been found to work well and is currently preferred, although various other materials from which selected color markings can be erased can be used. The currently preferred synthetic paper may be printed upon in color using small offset lit machines as well as standard printing machines and such printing is permanent and does not wash off the synthetic paper. The synthetic paper will accept crayon coloring using either newer washable crayons or standard crayons or washable marker coloring. The color markings from either type of crayon or form washable markers can be wiped from the synthetic paper with a wet cloth without affecting the material printed on the synthetic paper. The removal of the color marks from the synthetic paper is substantially complete and such removal can be done over and over again. Applicant has not yet discovered a limit to the number of times color marks can be removed and the synthetic paper thereafter colored again. While various crayons may be used with the synthetic paper, a water washable crayon has been found to work well and is presently preferred.

The coloring book includes outline indicia in the form of outline drawings 13, similar to the outline drawings in any coloring book, which are to be filled in (colored) with color marks by a user. In the invention, however, the coloring book also includes similar outline indicia 14 which includes color marks 15, i.e., the drawing is colored, to indicate to the user an appropriate way the drawing could be colored. This similar colored indicia is permanently printed in the book. This similar (sample) colored indicia is important for younger children particularly to show how the picture could be colored (color marks fill particular outline areas and do not cross or cover lines) and provide guidance as to particular colors to use if the user is not familiar with the subject matter ofthe drawing, e.g., correct colors for particular animals, flowers, or buildings that a child might not have seen or otherwise yet be familiar with. Having a sample colored drawing helps to teach, and aid in the development of, dexterity in the child using the coloring book.

The drawing to be colored and the similar colored drawing may be arranged as desired in the book, such as one on top of a page and the other on the bottom of the page or side-by-side on the page, or, as shown in FIG. 1, the drawing 13 to be colored may be on one page when the book is opened and the similar colored drawing 14 may be on the facing page. It is preferred that both the drawing 13 to be colored and the similar colored drawing 14 be simultaneously visible to a user. In this way, the user can view and follow to the extent desired the sample similar colored drawing.

In many instances, it may be desirable to include textual material, such as shown at 16, on selected pages of the book. This textual material is to be read by the user and may describe the drawing or scene to be colored or may tell a story to which the drawing to be colored relates. Thus, a reader for a child of selected age or reading ability can be produced with pictures relating to the story told in the reader provided to be colored by the reader. The textual material may be arranged on the pages with the drawing to be colored and the similar colored drawing in various ways, as desired.

The coloring book of the invention is a long lasting item in that the synthetic paper used is very durable and will stand up to hard use and in that the color marks can be erased multiple times so that the book can be used, the color marks washed off, and the book reused.

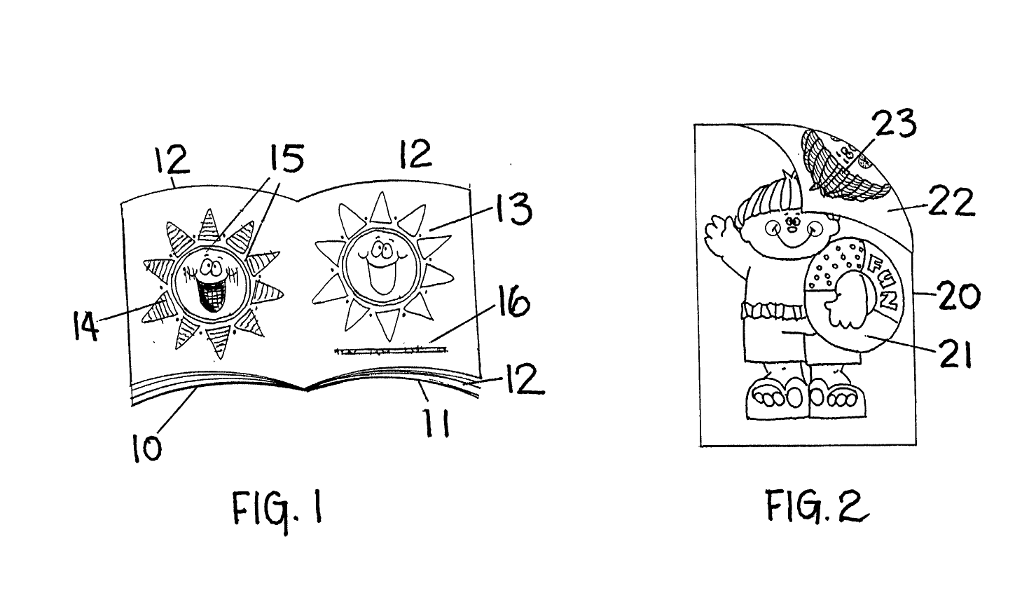

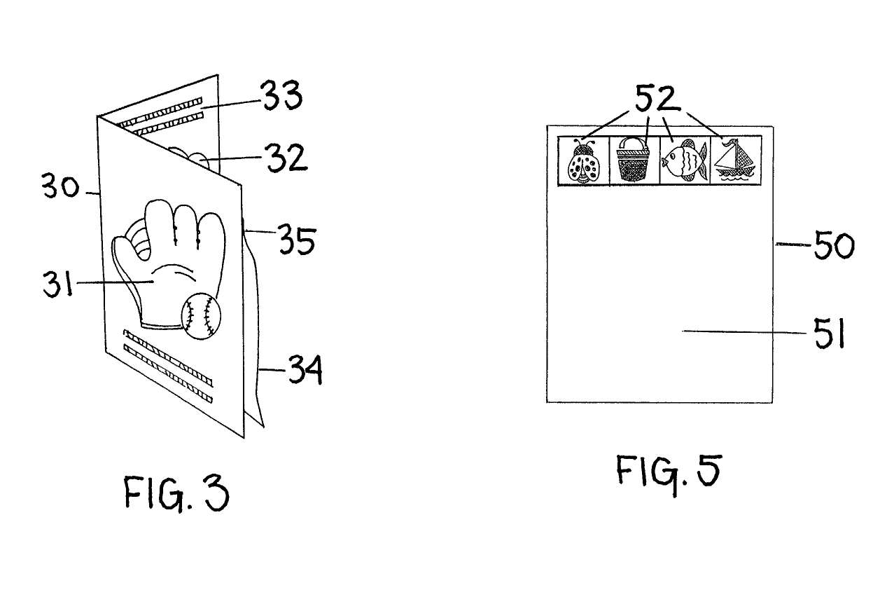

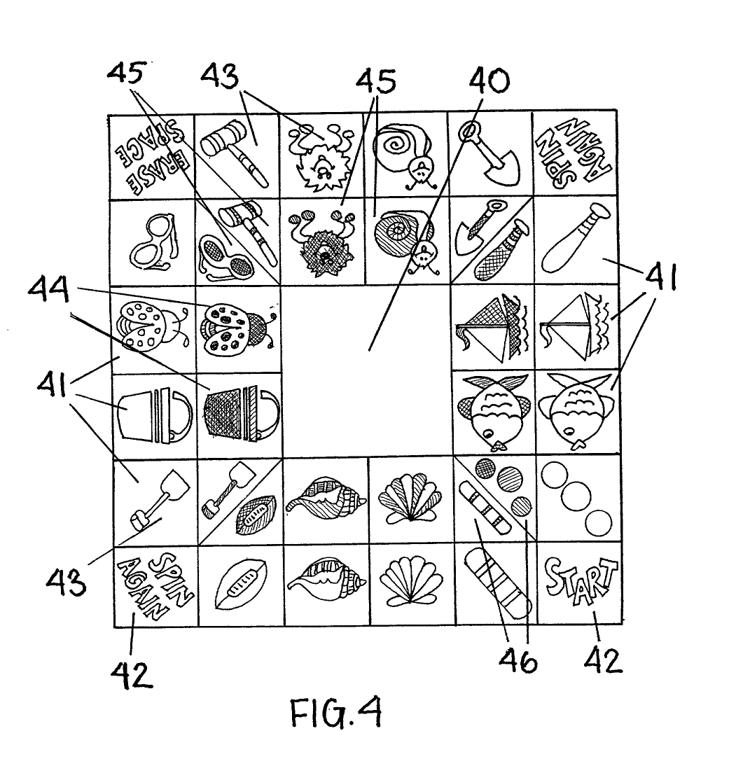

The invention can take various forms in addition to a coloring book. For example, the invention may take the form of a poster 20, FIG. 2. The poster may have the outline indicia 21 to be colored printed on one side of the poster and the similar indicia 22 with colored areas 23 printed on the opposite side of the poster. In use, the user will have to look at the colored side of the poster to get specific ideas for coloring a part of the poster, turn the poster over and color that part, turn the poster over again to look at another part of the similar colored indicia, turn over the poster and color that part of the poster, and continue in this manner until the poster is colored. Alternatively, the similar indicia may be printed on the same side of the poster as the indicia to be colored and located in various positions, as desired, such as in a top or bottom corner position. The similar colored indicia may be of a reduced size from the indicia to be colored.

The invention may take the form of a greeting card to be colored by a user. Thus, a greeting card 30 may have outline indicia 31 to be colored on the front thereof and, if desired, may also have additional outline indicia 32 to be colored on an inside face of the card. The outline indicia 31 and/or 32 may be a drawing or may be outlined words such as “Happy Birthday”, “Merry Christmas”, or “Happy Hanukkah”, which are to be colored. An area to add a message may be provided as at 33 on an inside surface of the card or on the front of the card. Alternatively, a message, such as “Happy Birthday”, “Merry Christmas”, or “Happy Hanukkah” may be printed on the card in a desired position. The similar indicia may not only include a similar colored drawing but may also include suggested sample messages. The user can work on the card, and if not satisfied with the coloring or the message, may erase the card or portions thereof, and re-do it or portions of it as often as desired until the card is satisfactory to the user. The similar indicia may be printed on the back of the card or on an interior portion of the card, or may be printed on a separate sheet of paper 34 attached to the card such as by an adhesive as at 35 which allows the paper 34 to be easily removed from the card, or the paper could be removably tucked into a receiving slot or pocket in a portion of the card. The object, if the similar indicia is on a separate sheet, is to have the similar indicia, i.e., the separate sheet with the similar indicia, come with the card at the time the card is sold to serve as a guide for the user in completing the card. Once the card is completed and sent or given to the recipient, it generally will not be erased and redone. The similar indicia is important as the card is initially prepared. If cards are packaged for sale in a box, the box may include the similar indicia for the card or cards packaged in the box.

The invention may also be provided in the form of tray liners, place mats, book covers, contest coloring kits, or school or home arts and crafts projects. In such cases, the similar colored indicia which serves as a guide to the user in completing the indicia to be colored may be supplies on a portion of the item itself, such as on the back of a tray liner or book cover, or as a separate sheet supplied with the item as sold and preferably removably attached to such item so that it remains with the item at least until initial completion of the item and removal of the sheet.

The invention may also serve as the basis of a board game. A game board 40 includes a number of spaces 41 extending around the outside perimeter of the board. Corner spaces 42 are provided at each comer. Each side space 41 includes outline indicia 43. Above each space 41 is an inner space 44 which include similar indicia 45 which is colored as a guide to coloring the particular side space 41. The comer inner spaces are divided into two spaces 46 to provide similar indicia for each of the side spaces adjoining it.

In play, a player starts on a comer space 42 designated as a start space. The player rolls dice or spins a spinner to get a number indicating the number of spaces to move. The player moves that number of spaces and lands on a space. If that space has not yet been colored, the player colors it. The next player moves and if he or she lands on an uncolored space, colors it. This play continues until all side spaces are colored, at which time the game ends. The player who has colored the most spaces at the end of the game wins. The corner spaces 42 may have outline indicia therein for coloring, but because it is difficult to provide similar indicia for such spaces, such corner spaces 42 may, in addition to the start space, have other instructions, such as “spin again”, “lose a turn”, “erase an opponent's space”, etc. With such game board, at least the side spaces are made of or covered with material that can be colored and have the color markings erased, such as by wiping with a wet cloth, as previously explained. Thus, the game can be played over and over again. Various other game and game board arrangements could be used in conjunction with areas that players color and then that can be erased so the game can be played again. Rather than having the indicia to be colored on the game board itself, which may be difficult for successive individual players to reach, with some games, the indicia can be supplied on separate boards which can be easily kept in the possession of a player during a game or easily passed from player to player during the game for coloring.

FIG. 5 shows an embodiment of the invention where rather than outline indicia, the device of the invention includes a blank area forming an area to be colored by the user. The similar indicia in such instance is one or more drawings which serve as guide indicia to the user in preparing a drawing in the blank area. This form of the invention can be used in teaching drawing or illustrating in that the similar indicia may indicate to a user how to draw a particular figure, or provide a sample illustration to be copied by the user. Thus, the device 50 of FIG. 5 has a blank area 51 with four drawings 52 positioned above the blank area. A user picks one of the drawings 52 to try to copy in the blank area. The user can try and if not satisfied, erase the blank area and try again. If satisfied, the user can erase the blank area and try one of the other drawings 52. The drawings 52 could be a series of instructional drawings so that a user would follow and move from one drawing 52 to the next, in completing a drawing in the blank area. In this instance, the blank area 51 is equivalent to the outline indicia described for other embodiments. The user or different users can use the device, erase, and re-use it until certain drawing or illustrating skills are learned.

While a currently preferred type of paper has been indicated, such paper can be used alone or can be secured to other materials to provide desired configurations, thicknesses, flexibilities, or rigidness to the device of the invention.

Whereas this invention is here illustrated and described with reference to embodiments thereof presently contemplated as the best mode of carrying out the invention in actual practice, it should be realized that various changes may be made in adapting the invention to different embodiments without departing from the broader inventive concepts disclosed herein and comprehended by the claims that follow.

1. An erasable coloring device, comprising:
a sheet of material which can be colored with coloring instruments and from which color markings can be erased;
outline indicia outlining areas to be colored by a user printed on the material in a manner so that it cannot be erased from the material;
similar indicia printed so that it cannot be erased from the material on which it is printed and associated with the material having the outline indicia printed thereon; and
color printed within outlined areas of the similar indicia so that it cannot be erased from the material on which it is printed to serve as a guide for a user coloring the outline indicia.

2. An erasable coloring device according to claim 1, wherein the similar indicia associated with the material having the outline indicia thereon can be seen by a user during coloring of the outline indicia.

3. An erasable coloring device according to claim 2, wherein the similar indicia is printed on the material on which the outline indicia is printed and is arranged on such material so that a user can see both the outline indicia and the similar indicia while coloring the outline indicia.

4. An erasable coloring device according to claim 3, wherein the device is a coloring book having pages therein, and wherein, when the book is opened, both the outline indicia and the similar indicia is visible to the user.

5. An erasable coloring device according to claim 4, wherein, when the book is opened, the outline indicia is on one page of the book and the similar indicia is on a facing page of the book.

6. An erasable coloring device according to claim 5, wherein the book includes text related to the outline indicia.

7. An erasable coloring device according to claim 6, wherein the material forming the pages of the book is substantially waterproof and tear resistant.

8. An erasable coloring device according to claim 2, wherein the similar indicia is printed on separate material from the material on which the outline indicia is printed, and such similar indicia is positionable so that a user can see the similar indicia during coloring of the outline indicia.

9. An erasable coloring device according to claim 8, wherein the material having the similar indicia printed thereon is removably secured to the material having the outline indicia printed thereon.

10. An erasable coloring device according to claim 1, wherein the similar indicia is printed on the material on which the outline indicia is printed, but is not visible simultaneously with the outline indicia.

11. An erasable coloring device according to claim 10, wherein the material on which the outline indicia is printed has two sides and the outline indicia is printed on one side of the material while the similar indicia is printed on the other side of the material.

12. An erasable coloring device according to claim 1, wherein the material on which the outline indicia is printed is substantially waterproof and tear resistant.

13. An erasable coloring device according to claim 1, wherein the device is a game board which has game spaces thereon, and wherein the outline indicia is included in selected game board spaces which players color when first to land on such space.

14. An erasable coloring device according to claim 1, wherein the device is a game board which has game spaces thereon, and wherein the outline indicia is included in selected game board spaces which players color when directed to do so during play of the game.

15. An erasable coloring device comprising:
erasable material which can be colored by coloring instruments and from which color marking can be erased;
an area to be colored by a user defined by the device on at least a portion of the erasable material so that said area can be colored and erased as desired by the user; and
non-erasable guide indicia including at least one colored drawing to serve as a guide to a user in coloring the area to be colored.

16. An erasable coloring device according to claim 15, wherein the guide indicia includes a plurality of colored drawings from which the user can choose to guide such user in coloring the area to be colored.

17. An erasable coloring device according to claim 15, wherein the guide indicia includes a plurality of colored drawings which the user follows in step-by-step manner to guide the user in coloring the area to be colored.

18. An erasable coloring device according to claim 15, wherein the non-erasable guide indicia is printed on the erasable material adjacent to the area to be colored by the user.

19. An erasable coloring device according to claim 15, wherein the area to be colored by the user includes outline indicia outlining areas to be colored by the user printed on the material in a manner so it cannot be erased from the material, and the guide indicia is indicia similar to the outline indicia including color within outline areas of the guide indicia to guide the user in coloring the outline indicia.
